(19) United States
(12) Patent Application Publication
(10) Pub. No.: US 2017/0321955 A1
(43) Pub. Date: Nov. 9, 2017

(54) Vacuum Insulation Body

(71) Applicants: LIEBHERR-HAUSGERATE LIENZ GMBH, Lienz (AT); LIEBHERR-HAUSGERATE OCHSENHAUSEN GMBH, Ochsenhausen (DE)

(72) Inventors: Jochen Hiemeyer, Karlstadt (DE); Michael Freitag, Wurzburg (DE); Martin Kerstner, Wurzburg (DE)

(21) Appl. No.: 15/529,521

(22) PCT Filed: Oct. 23, 2015
(86) PCT No.: PCT/EP2015/002108

§ 371 Date: May 25, 2017

(30) Foreign Application Priority Data
Nov. 27, 2014 (DE) 10 2014 017 597.9
Dec. 8, 2014 (DE) 10 2014 018 071.9
Jan. 22, 2015 (DE) 10 2015 000 821.8
Jun. 24, 2015 (DE) 10 2015 008 124.1

(51) Int. Cl. F25D 23/06; F16L 59/065

(52) U.S. Cl. CPC F25D 23/062; F16L 59/065; F25D 2201/14

(57) ABSTRACT

The present invention comprises a vacuum insulation body comprising a vacuum-tight covering that surrounds an evacuated region, wherein a core material is arranged in the evacuated region, wherein the covering has an outer region and an inner region at least partially surrounded by the outer region, wherein the inner region and the outer region are formed by a common film bag and wherein the inner region is formed by inverting the film bag.

The present invention relates to a vacuum insulation body comprising at least one vacuum-tight covering that surrounds an evacuated region, wherein a core material such as perlite is arranged in the evacuated region.

Such a vacuum insulation body is known, for example, from DE 10 2013 005 585 A1. The vacuum insulation body known from this patent application comprises a diffusion-tight, i.e. vacuum-tight, covering whose surface is larger than the surface of the covering body such as of an inner container which the covering contacts. It is thus, for example, possible to be able to model projecting or set-back contours of the covering body in the covering.

The possibility is described in DE 10 2013 005 585 A1 of producing the vacuum insulation body of an inner cover and an outer cover. Such a separate manufacture of the two cover elements is complex and/or expensive, on the one hand, and the vacuum-tight sealing is complicated and possibly prone to error, on the other hand, due to the necessity of a welding at a three-dimensional film contour bag.

It is thus the underlying object of the present invention to further develop a vacuum insulation body of the initially named kind such that its manufacture is comparatively simple and reliable.

This object is achieved by a vacuum insulation body having the features of claim 1.

Provision is accordingly made that the covering has an outer region and an inner region at least partially surrounded by the outer region, wherein the inner region and the outer region are formed by a common film bag and wherein the inner region is formed by inverting the film bag. The inner side of the vacuum insulation body that is adjacent to the inner container of the refrigerator unit and/or freezer unit and the outer side of the vacuum insulation body that is adjacent to the outer housing of the refrigerator unit and/or freezer unit are formed in accordance with the invention by a common part in the form of a common film sack or of a common tubular film.

It is the underlying idea of the present invention to configure the inner cover, i.e. the inner region, and the outer cover, i.e. the outer region, of the vacuum insulation body not from two separate film pieces, but rather by a common film bag.

The inner region is formed in that the film bag is inwardly inverted. The necessity of having to carry out the sealing at complex weld spots thus no longer applies since the inner region and the outer region are formed by one and the same film bag.

There is only the necessity of closing the film bag in a vacuum-tight manner after the filling with core material. A further vacuum-tight covering can be used for this purpose that is e.g. placed onto the marginal region of the outer region and is connected or sealed thereto in a vacuum-tight manner.

The film bag preferably comprises a bag that is open at one side, whose open side is surrounded by the margin of the outer region and whose closed side forms the base surface of the inner region after the inversion.

Provision is preferably made that the inner region has a base and that the margin of the film bag is arranged at the same side of the vacuum insulation body as the base of the inner region.

Provision is preferably made that the outer region has a peripheral margin or a peripheral edge that is formed by the end region or margin of the film bag.

Provision is made in a preferred embodiment of the invention that the vacuum-tight covering partially or completely consists of or comprises a high barrier film.

Provision is preferably made that the vacuum-tight covering partially or completely consists of or comprises a laminated aluminum film.

Provision is made in a particularly preferred embodiment of the invention that the transition region between the inner region and the outer region of the film bag partially or completely comprises a different film type or material than the film forming the actual outer region and/or the actual inner region. It is thereby possible to give this transition region different thermal insulation properties than the further regions of the film bag.

The transition region preferably also comprises, like the inner region and the outer region, a high barrier film.

The named transition region preferably represents an integral element of the film bag.

It is thus conceivable, for example, that the other film type that forms the transition region is a metalized film. It is, for example, conceivable that it is a film onto which a metal layer, preferably an aluminum layer, has been vacuum deposited.

Provision is made in a further embodiment of the invention that the film bag is a square bottom bag.

Provision can furthermore be made that the film bag is a film contour bag that has one or more recesses.

These cut-outs can, for example, be obtained in that the bag is folded inwardly such that a recess arises and in that the projecting surfaces are sealed and then cut off.

The present invention furthermore relates to a film bag that is in particular suitable for manufacturing a vacuum insulation body in accordance with the invention and can be used therefore.

The film bag has at least one outer region and at least one inner region at least partially surrounded by the outer region, wherein the inner region is formed by inverting the film bag.

Provision is furthermore made that the transition region between the inner region and the outer region at least partially comprises a different film type than the film forming the outer region and the inner region.

As stated above, the transition region preferably represents an integral element of the film bag.

The other film type that forms the transition region is preferably a metalized film.

It is preferred if the film bag consists of or comprises a high barrier film.

It is particularly advantageous if the film bag consists of or comprises a laminated aluminum film. This laminated aluminum film has at least one aluminum film. Additional layers can be formed by plastic layer, for example.

Provision is preferably made that the inner region and/or the outer region of the film bag comprise a laminated aluminum film. The transition region preferably comprises a metalized film that is obtained, for example, by vacuum deposition of a metal such as aluminum onto a substrate, preferably onto a plastic substrate.

As stated above, it is particularly advantageous if the film bag is configured as a square bottom bag.

To be able to model contours of the covering body such as of an inner container, it is particularly advantageous if the film bag is a film contour bag that has one or more recesses such as a concave indentation that is required for the compressor niche of the unit.

This recess can, for example, be formed in that the film contour bag is folded inward and in that the projecting half-side surfaces are sealed in the angular region and are cut-off toward the seal seam.

The present invention furthermore relates to a thermally insulated container, preferably to a refrigerator unit and/or freezer unit having at least one temperature-controlled, and preferably cooled, inner space and having at least one wall at least regionally surrounding the temperature controlled, and preferably cooled, inner space, wherein a vacuum insulation body in accordance with the invention is located between the temperature-controlled, and preferably cooled, inner space and the wall.

The temperature-controlled inner space is either cooled or heated depending on the type of the unit (refrigerator unit, heating cabinet, etc.) Thermally insulated containers in the sense of the present invention have at least one temperature-controlled inner space, with this being able to be cooled or heated so that a temperature results in the inner space below or above the environmental temperature of e.g. 21° C. The invention is therefore not restricted to refrigerator units and/or freezer units, but rather generally applies to units having a temperature-controlled inner space, for example also to heat cabinets or heat chests.

With respect to this container in accordance with the invention, the vacuum insulation body in accordance with the invention preferably represents a full vacuum system that is arranged in the space between the inner wall bounding the inner space of the container or unit and the outer skin of the container or unit. A thermal insulation is to be understood by a full vacuum system which comprises only or primarily an evacuated region which is filled with a core material. The bounding of this region can be formed, for example, by a vacuum-tight film and preferably by a high barrier film. Only such a film body can thus be present between the inner wall of the container, preferably the unit, and the outer skin of the container, preferably of the unit, as the thermal insulation which has a region which is surrounded by a vacuum-tight film, in which there is a vacuum and in which a core material is arranged. A foaming and/or a vacuum insulation panels is/are preferably not provided as thermal insulation or another thermal insulation is not provided, except for the full vacuum system between the inner side and the outer side of the container.

This preferred form of thermal insulation in the form of a full vacuum system can extend between the wall bounding the inner space and the outer skin of the carcass and/or between the inner side and the outer side of the closing element such as a door, flap, lid, or the like.

The full vacuum system can be obtained such that an covering of a gas-tight film is filled with a core material and is subsequently sealed in a vacuum-tight manner. In an embodiment, both the filling and the vacuum-tight sealing of the covering take place at normal or environmental pressure. The evacuation then takes place by the connection to a vacuum pump of a suitable interface worked into the covering, for example an evacuation stub which can have a valve. Normal or environmental pressure is preferably present outside the covering during the evacuation. In this embodiment, it is preferably not necessary at any time during the manufacture to introduce the covering into a vacuum chamber. A vacuum chamber can be dispensed with in an embodiment to this extent during the manufacture of the vacuum insulation.

Provision is made in an embodiment that the container in accordance with the invention is a refrigerator unit and/or a freezer unit, in particular a domestic appliance or a commercial refrigerator. Such units are, for example, covered which are designed for a stationary arrangement at a home, in a hotel room, in a commercial kitchen or in a bar. It can, for example, be a wine cooler. Chest refrigerators and/or freezers are furthermore also covered by the invention. The units in accordance with the invention can have an interface for connection to a power supply, in particular to a domestic mains supply (e.g. a plug) and/or can have a standing aid or installation aid such as adjustment feet or an interface for fixing within a furniture niche. The unit can, for example, be a built-in unit or also a stand-alone unit.

The container or the unit is preferably configured such that it can be operated at an AC voltage such as a domestic mains voltage of e.g. 120 V and 60 Hz or of 230 V and 50 Hz. It is conceivable in an alternative embodiment that the container or the unit is configured such that it can be operated with DC current of a voltage of, for example, 5 V, 12 V or 24 V. Provision can be made in this embodiment that a plug power supply is provided inside or outside the unit via which the unit is operated. Operation with DC voltage can in particular be used when the container has a thermoelectric heat pump for controlling the temperature of the inner space.

Provision can in particular be made that the refrigerator unit and/or freezer unit has a cabinet-type design and has a useful space which is accessible to a user at its front side (at the upper side in the case of a chest). The useful space can be divided into a plurality of compartments which are all operated at the same temperature or at different temperatures. Alternatively, only one compartment can be provided. Storage aids such as trays, drawers or bottle-holders (also dividers in the case of a chest) can also be provided within the useful space or within a compartment to ensure an ideal storage of refrigerated goods or frozen goods and an ideal use of the space.

The useful space can be closed by at least one door pivotable about a vertical axis. In the case of a chest, a lid pivotable about a horizontal axis or a sliding cover is conceivable as the closing element. The door or another closing element can be connected in a substantially airtight manner to the carcass by a peripheral magnetic seal in the closed state. The door or another closing element is preferably also thermally insulated, with the thermal insulation being able to be achieved by a foaming and optionally by vacuum insulation panels or also preferably by a vacuum system and particularly preferably by a full vacuum system. Door storage areas can optionally be provided at the inside of the door in order also to be able to store refrigerated goods there.

It can be a small appliance in an embodiment. In such units, the useful space defined by the inner wall of the container has, for example, a volume of less than 0.5 m³, less than 0.4 m³ or less than 0.3 m³. The outer dimensions of the container or unit are preferably in the range up to 1 m with respect to the height, width and depth.

A vacuum-tight or diffusion-tight covering or a vacuum-tight or diffusion-tight connection or the term high barrier film is preferably understood as a covering or as a connection or as a film by means of which the gas input into the vacuum insulation body is reduced so much that the increase in the thermal conductivity of the vacuum insulation body caused by gas input is sufficiently low over its service life. A time period of 15 years, preferably of 20 years, and particularly preferably of 30 years, is to be considered as the service life, for example. The increase in the thermal conductivity of the vacuum insulation body caused by gas input is preferably <100%, and particularly preferably <50%, over its service life.

The surface-specific gas flow rate of the covering or of the connection or of the high barrier film is preferably <10⁻⁵ mbar*l/s*m² and particularly preferably <10⁻⁶ mbar*l/s*m² (measured according to ASTM D-3985). This gas flow rate applies to nitrogen and to oxygen. There are likewise low gas flow rates for other types of gas (in particular steam), preferably in the range from <10⁻² mbar*l/s*m² and particularly preferably in the range from <10⁻³ mbar*l/s*m² (measured according to ASTM F-1249-90). The aforesaid small increases in the thermal conductivity are preferably achieved by these small gas flow rates.

A covering system known from the sector of vacuum panels are so-called high barrier films. Single-layer or multilayer films (which are preferably able to be sealed) having one or more barrier layers (typically metal layers or oxide layers, with aluminum and an aluminum oxide preferably being used as the metal or oxide respectively) are preferably understood by this within the framework of the present invention which satisfy the above-named demands (increase in thermal conductivity and/or surface-specific gas flow rate) as a barrier to the gas input.

The above-named values or the make-up of the high barrier film are exemplary, preferred values which do not restrict the invention.

Further details and advantages of the invention will be explained in more detail with reference to an embodiment shown in the drawing. There are shown:

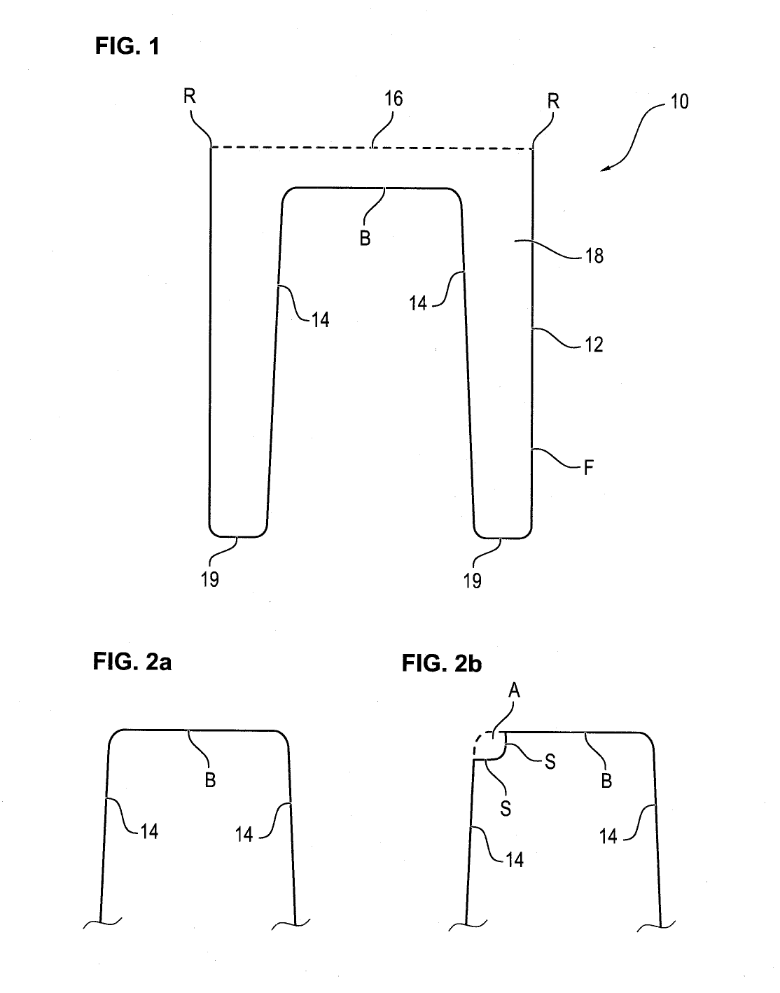

FIG. 1: a sectional view through a vacuum insulation body in accordance with the invention;

FIG. 2: a partial view of the inner region of a vacuum insulation body in accordance with the invention; and

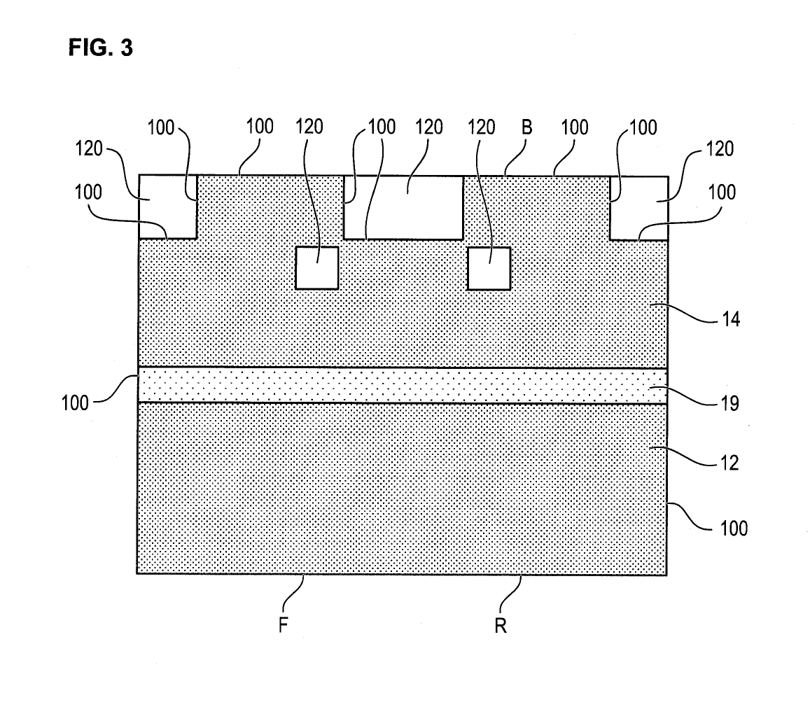

FIG. 3: a film pattern for manufacturing a film bag for a vacuum insulation body in accordance with the invention.

FIG. 1 shows a vacuum insulation body in accordance with the present invention with the reference symbol 10.

The vacuum insulation body 10 comprises a vacuum-tight covering that is formed from the film bag F, on the one hand, and from a film 16, on the other hand, that are connected or sealed to one another in a vacuum-tight manner.

There is a vacuum inside the vacuum-tight covering. A core material such as perlite is located as a support body in this evacuated region.

In accordance with the invention, the vacuum insulation body comprises the film bag F or the tubular bag that has an outer region 12 and an inner region 14. These regions comprise a vacuum-tight, preferably sealable, film, preferably composed of a laminated aluminum film. The region 18 located therebetween is evacuated and filled with the core material. This applies accordingly to the region between the base B of the inner region 14 and the cover film 16.

As can be seen from FIG. 1, the covering is formed in that a film bag F whose open region is at the top in accordance with FIG. 1 and that is otherwise closed, is inverted inwardly or upwardly in accordance with FIG. 1 so that an inwardly disposed region 14 results that is surrounded by the outwardly disposed region 12.

There is a transition region 19 between the regions 12 and 14.

The regions 12, 14 and 19 are all integral elements of a common film bag F.

As can be seen from FIG. 1, the base B of the inner region 14 is on the same side of the vacuum insulation body 10 as the margin R of the film bag. The margin R and the base are respectively arranged at the top in accordance with FIG. 1.

In the condition ready for use, the margin R and the base B are at the bottom.

The inner region 14 serves for receiving an inner container and the outer region 12 is arranged adjacent to an outer housing of a refrigerator unit or freezer unit. The inner container comprises plastic, for example; the outer jacket likewise comprises plastic or also metal, for example.

In accordance with the invention, the inner region 14 and the outer region 12 of the vacuum insulation body 10 or of the vacuum-tight covering are formed by a single film bag and not by a plurality of elements or film pieces that have to be welded together.

This brings about the advantage that, in accordance with FIG. 1, only one single weld seam has to be applied, and indeed a weld seam that can preferably be arranged in a planar surface. This weld seam serves the fixing of the cover film 16 on the peripheral marginal region R of the film bag or of the outer region 12 or the manufacture of a vacuum-tight connection between the film 16 and the outer region 12 or of its margin R.

The film bag preferably comprises a high barrier film in the regions 12 and 14. The same applies accordingly to the peripheral transition region 19 that connects the regions 12 and 14 to one another.

The regions 12 and 14 furthermore preferably comprise a laminated aluminum film, whereas the transition region 19 comprises a metalized film that has a higher resistance to a thermal passage than the laminated aluminum film 12, 14. It is possible in this manner to realize the transition region 19, that is e.g. at the top in a finished refrigerator unit or freezer unit, in particular in a chest, with a minimized thermal transfer.

It is also possible as part of the present invention, to contour the inner region 14 and/or the outer region 12 or to provide a film contour bag that has a specific contour that is adapted to the finished unit.

It is thus conceivable, for example, to form a recess, that is mapped to the compressor niche, in the film bag that is shown only partially by its inner region 14 in FIG. 2a). This is achieved in that, starting from the condition in accordance with FIG. 2a, a side region, for example the top left corner, is folded inward and the half side surfaces in accordance with FIG. 2b) that are marked by the reference symbol A are sealed by seal seams S with respect to the adjacent film region and then only the region A is cut off.

It is thus possible to establish a recess, i.e. a concave dimple or the like e.g. in the inner region of the film bag. This ensures that the inner region 14 contacts an inner container with as faithful a contour as possible, said inner container being placed into the inner region 14.

Corresponding measures can naturally also be carried out for other regions of the inner region and/or of the outer region.

FIG. 3 shows a film pattern that comprises rolled goods, for example. This film pattern has the later inner region 14, the later outer region 12, and the transition region 19.

The film pattern comprises a planar high barrier film that is sealed along surfaces marked by the reference numeral 100 so that a film bag is produced.

The high barrier film can be a film sealable at one side or at both sides.

A film bag can be produced from the film pattern in accordance with FIG. 3 by placing the film side at the right in accordance with FIG. 3 onto the film side at the left in accordance with FIG. 3 and by a subsequent sealing around the periphery except for the lower side. Bag clamps can e.g. be fastened to said film bag for an easier handling. They can serve as a reference point for the film bag handling in the further process.

Surfaces are marked by the reference numeral 120 that are cut away after the manufacture of the film bag or after the sealing along the seam S as was explained in more detail with reference to FIG. 2b).

As stated there, a compressor niche can be molded, for example; the corners can be sealed and the regions 120 can be cut off.

In this manner, a film contour bag can be manufactured in which already projecting and/or recessed contours are worked so that said film contour bag or the vacuum body manufactured therefrom contacts the inner container or an outer jacket of a refrigerator unit and/or freezer unit with as faithful a contour as possible.

After the inward inversion of the bag base, the region 14 forms the inner region that contacts the inner container of the unit and the region 12 forms the outer region that contacts the jacket or housing of the unit. The strip 19 forms the transition region between the regions 12 and 14. It forms the upper marginal region of the vacuum body in the unit. It can, for example, be arranged below the frame of a chest refrigerator and/or chest freezer. The inversion thus takes place such that only the region from the region 19 onward is inwardly inverted.

1. A vacuum insulation body comprising a vacuum-tight covering that surrounds an evacuated region, wherein a core material is arranged in the evacuated region,
characterized in that
the covering has an outer region and an inner region at least partially surrounded by the outer region, wherein the inner region and the outer region are formed by a common film bag and wherein the inner region is formed by inverting the film bag.

2. A vacuum insulation body in accordance with claim 1, characterized in that the inner region has a base and that the margin of the film bag is arranged at the same side of the vacuum insulation body as the base of the inner region.

3. A vacuum insulation body in accordance with claim 1, characterized in that the outer region has a peripheral margin that is formed by the margin of the film bag.

4. A vacuum insulation body, characterized in that the vacuum-tight covering consists of or comprises a high barrier film.

5. A vacuum insulation body in accordance with claim 1, characterized in that the vacuum-tight covering consists of or comprises a laminated aluminum film.

6. A vacuum insulation body in accordance with claim 1, characterized in that the transition region between the inner region and the outer region partially or completely comprises a different type of film than the film forming the outer region and/or the inner region.

7. A vacuum insulation body in accordance with claim 6, characterized in that the different film type is a metalized film.

8. A vacuum insulation body in accordance with claim 1, characterized in that the film bag is a square bottom bag and/or in that the film bag is a film contour bag that has one or more recesses.

9. A film bag for manufacturing a vacuum insulation body in accordance with claim 1,
characterized in that
the film bag has an outer region and an inner region at least partially surrounded by the outer region, with the inner region being formed by inverting the film bag; and in that the transition region between the inner region and the outer region partially or completely comprises a different film type than the film forming the outer region and/or the inner region.

10. A film bag in accordance with claim 9, characterized in that the different film type is a metalized film.

11. A film bag in accordance with claim 9, characterized in that the film bag consists of or comprises a high barrier film.

12. A film bag in accordance with claim 9, characterized in that the film bag consists of or comprises a laminated aluminum film.

13. A film bag in accordance with claim 9, characterized in that the film bag is formed as a square bottom bag and/or in that the film bag is a film contour bag that has one or more recesses.

14. A thermally insulated container having a temperature controlled inner space and having at least one wall at least regionally surrounding the temperature controlled inner space,
characterized in that
a vacuum insulation body in accordance with claim 1 is located between the temperature controlled inner space and the wall.

15. A vacuum insulation body in accordance with claim 8, characterized in that the recess is formed by sealing and cutting off of the side surfaces of the recess.

16. A film bag in accordance with claim 13, characterized in that the recess is formed by sealing and cutting off of the side surfaces of the recess.
